(19) United States
(12) Patent Application Publication
(10) Pub. No.: US 2026/0113827 A1
(43) Pub. Date: Apr. 23, 2026

(54) Intelligent City Streetlight Control System and Streetlight Control Box and Streetlight Therefor

(71) Applicant: JO-CHIEH CHIANG, Taoyuan City (TW)

(72) Inventor: JO-CHIEH CHIANG, Taoyuan City (TW)

(21) Appl. No.: 19/363,446

(22) Filed: Oct. 20, 2025

(30) Foreign Application Priority Data
Oct. 21, 2024 (TW) 113139942

(51) Int. Cl. H05B 47/175; F21S 8/08; G06Q 30/018; H04L 67/12

(52) U.S. Cl. CPC H05B 47/175; G06Q 30/018; H04L 67/12; F21S 8/085

(57) ABSTRACT

An intelligent city streetlight control system and a streetlight control box and a streetlight therefor are provided. The streetlight control box is configured to install various network devices and provide network management, power management, and edge computing for the network devices to meet the construction requirements of a smart city. The provided streetlight control box is optionally equipped with a battery module, which supplies power to the network devices and power circuits to fulfill the power requirements of the smart city.

### CROSS-REFERENCE TO RELATED APPLICATIONS

This application claims the priority of Republic of China Patent Application No. 113139942 filed on Oct. 21, 2024, in the State Intellectual Property Office of the R.O.C., the disclosure of which is incorporated herein by reference.

### BACKGROUND OF THE INVENTION

### Field of the Invention

The present application relates to the technical field of installation of various network devices, and more particularly, to a smart city streetlight control system configured to install various network devices in compliance with construction requirements of a smart city, and a streetlight control box and a streetlight associated with the smart city streetlight control system.

### Descriptions of the Related Art

With the continuous development of network technologies and the increasing level of urban informatization, a smart city has been accordingly constructed. Its construction inevitably relies on the network and power infrastructure for network devices. In other words, it is necessary to provide network connectivity and power for network devices in various public areas of the smart city so that the network devices can be ubiquitous throughout the smart city. The network devices may comprise, for example, network surveillance cameras used for urban security management or traffic monitoring, or network environmental detectors used for monitoring urban environmental quality.

In view of the above, how to provide network connectivity and power for network devices in various public areas of a city so as to develop it into a smart city, has become a technical problem to be solved by the present invention.

### SUMMARY OF THE INVENTION

In view of the drawbacks of the prior art mentioned above, the present application provides a streetlight control box disposed at an edge side and configured to cooperate with a power circuit and a network circuit to provide power and a network respectively from the power circuit and the network circuit, the streetlight control box further being configured to cooperate with a management server room and a network device, wherein the management server room is located at a management side and is configured to provide a management server room network message, and the network device is located at the edge side and is configured to provide a network device message, wherein the management side is located remotely, and the edge side is located locally; the streetlight control box comprises: a control box body; a battery module configured to store the power at the edge side; a power management module, connected to the power circuit and the battery module, and configured to provide power management by activating a circuit power supply mode and a battery power supply mode, wherein, when the circuit power supply mode is activated, the power management module enables the power circuit to supply the power to the network device; when the battery power supply mode is activated, the power management module enables the battery module to supply the power to the network device via the power circuit; an edge computing module configured to perform edge computing on the network device message at the edge side so as to generate an edge computing network message; and a network management module connected to the network circuit and the edge computing module, and configured to provide network management by activating a network message transmission mode and an edge computing mode, wherein, when the network message transmission mode is activated, the network management module enables the network circuit to provide the network for the management server room and the network device, so as to transmit the network device message to the management server room or transmit the management server room network message to the network device; when the edge computing mode is activated, the network management module enables the network circuit to provide the network for the edge computing module and the network device, so as to transmit the network device message to the edge computing module and transmit the edge computing network message to the network device.

Preferably, the streetlight control box said above, wherein the battery module is disposed in the network device.

Preferably, the streetlight control box said above, further comprising a carbon credit management module connected to the power circuit and for acquiring statuses of the power supplied by the power circuit to the network device, thereby providing carbon credit management.

Preferably, the streetlight control box said above, further comprising a carbon credit trading module connected to the carbon credit management module and for acquiring carbon credit management statuses from the carbon credit management module, thereby providing carbon credit trading.

Preferably, the streetlight control box said above, further comprising a power trading module configured to trade the power with the network device or the power circuit, wherein, when the power trading module trades the power with the network device, the power management module enables the power circuit to supply the traded power to the network device; and when the power trading module trades the power with the power circuit, the power management module enables the battery module to supply the traded power to the power circuit.

Preferably, the streetlight control box said above, further comprising a network trading module configured to trade the network with the network device or the network circuit, wherein, when the network trading module trades the network with the network device, the network management module enables the network circuit to provide the traded network for the network device; and when the network trading module trades the network with the network circuit, the network management module enables the network circuit to receive the traded network.

Preferably, the streetlight control box said above, further comprising a box body space rental module, wherein the control box body comprises a box body rental space, and the box body space rental module is configured to rent the box body rental space so as to allow the network device to operate within the box body rental space.

Preferably, the streetlight control box said above, further comprising a box body space management module configured to manage an environment of the box body rental space to meet operating requirements of the network device.

Preferably, the streetlight control box said above, further comprising a box body space temperature regulation module, wherein the box body space management module is connected to the box body space temperature regulation module and regulates temperature of the environment of the box body rental space via the box body space temperature regulation module.

Preferably, the streetlight control box said above, further comprising a box body space humidity regulation module, wherein the box body space management module is connected to the box body space humidity regulation module and regulates humidity of the environment of the box body rental space via the box body space humidity regulation module.

Preferably, the streetlight control box said above, further comprising a box body optical beam power transmission module, wherein the power management module is connected to the box body optical beam power transmission module, and when the circuit power supply mode is activated, the power management module transmits the power via the box body optical beam power transmission module through an optical beam, thereby enabling the power circuit to supply the power to the network device; and when the battery power supply mode is activated, the power management module transmits the power via the box body optical beam power transmission module, thereby enabling the battery module to supply the power to the network device via the power circuit.

Preferably, the streetlight control box said above, further comprising a box body network device positioning module, wherein the box body optical beam power transmission module is connected to the box body network device positioning module, and is configured to locate the network device via the box body network device positioning module and to supply the power to the located network device through the optical beam.

Preferably, the streetlight control box said above, wherein the battery module, the power management module, the edge computing module, and the network management module are disposed inside or outside the control box body.

Additionally, the present application provides a streetlight configured to cooperate with the streetlight control box of claim 11 and located at the edge side, the streetlight comprising a streetlight body and a streetlight space rental module, wherein the streetlight body comprises a streetlight rental space, and the streetlight space rental module is configured to rent the streetlight rental space so as to allow the network device to operate within the streetlight rental space.

Preferably, the streetlight said above, wherein the battery module is disposed in the streetlight body or the control box body, and the streetlight space rental module is disposed in the streetlight body or the control box body.

Preferably, the streetlight said above, further comprising a streetlight space management module configured to manage an environment of the streetlight rental space to meet operating requirements of the network device.

Preferably, the streetlight said above, further comprising a streetlight space temperature regulation module, wherein the streetlight space management module is connected to the streetlight space temperature regulation module and regulates temperature of the environment of the streetlight rental space via the streetlight space temperature regulation module.

Preferably, the streetlight said above, further comprising a streetlight space humidity regulation module, wherein the streetlight space management module is connected to the streetlight space humidity regulation module and regulates humidity of the environment of the streetlight rental space via the streetlight space humidity regulation module.

Preferably, the streetlight said above, further comprising a streetlight optical beam power transmission module, wherein the power management module is connected to the streetlight optical beam power transmission module, and when the circuit power supply mode is activated, the power management module transmits the power via the streetlight optical beam power transmission module through an optical beam, thereby enabling the power circuit to supply the power to the network device; and when the battery power supply mode is activated, the power management module transmits the power via the streetlight optical beam power transmission module, thereby enabling the battery module to supply the power to the network device via the power circuit.

Preferably, the streetlight said above, further comprising a streetlight network device positioning module, wherein the streetlight optical beam power transmission module is connected to the streetlight network device positioning module, and the streetlight optical beam power transmission module is configured to locate the network device via th streetlight network device positioning module and to supply the power to the located network device through the optical beam.

Additionally, the present application provides a smart city streetlight control system comprising: a plurality of streetlight control boxes of claim 1, wherein the streetlight control boxes are configured to provide the power for each other via optical beams.

In comparison with the prior art, the present application provides an intelligent city streetlight control system and a streetlight control box and a streetlight therefor. The streetlight control box is capable of accommodating various network devices and providing network management, power management, and edge computing for the network devices, thereby meeting the construction requirements of an intelligent city. The provided streetlight control box may be equipped with a battery module for supplying power to the network devices and a power circuit, thereby fulfilling the power demand of the intelligent city.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic block diagram showing the architecture of an embodiment of the streetlight control box and streetlight of the present application.

FIG. 2 is a schematic block diagram showing the architecture of an embodiment of the streetlight control box and streetlight of the present application.

FIG. 3 is a schematic block diagram showing the architecture of an embodiment of the smart city streetlight control system of the present application.

FIG. 4 is a schematic block diagram showing the architecture of an embodiment of the streetlight control box of the present application.

FIG. 5 is a perspective schematic diagram showing an embodiment of the streetlight of the present application.

FIG. 6 is a perspective schematic diagram showing an embodiment of the streetlight of the present application.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

The present application provides a smart city streetlight control system, along with its streetlight control box and streetlight, to meet the installation requirements of various network devices and related equipment in smart cities. In general, a streetlight control box is configured for power distribution and switching of the streetlight circuit, and for interfacing with the public power grid. Currently, for every 30 streetlights in a city, at least one streetlight control box is typically installed to control them. Therefore, streetlight control boxes and their corresponding streetlights are densely distributed throughout the city and can serve as energy centers providing power. Accordingly, the present application utilizes these streetlight control boxes and their streetlights to supply both power and network connectivity to network devices, thereby constructing a smart city streetlight control system to meet the infrastructure needs of smart city development.

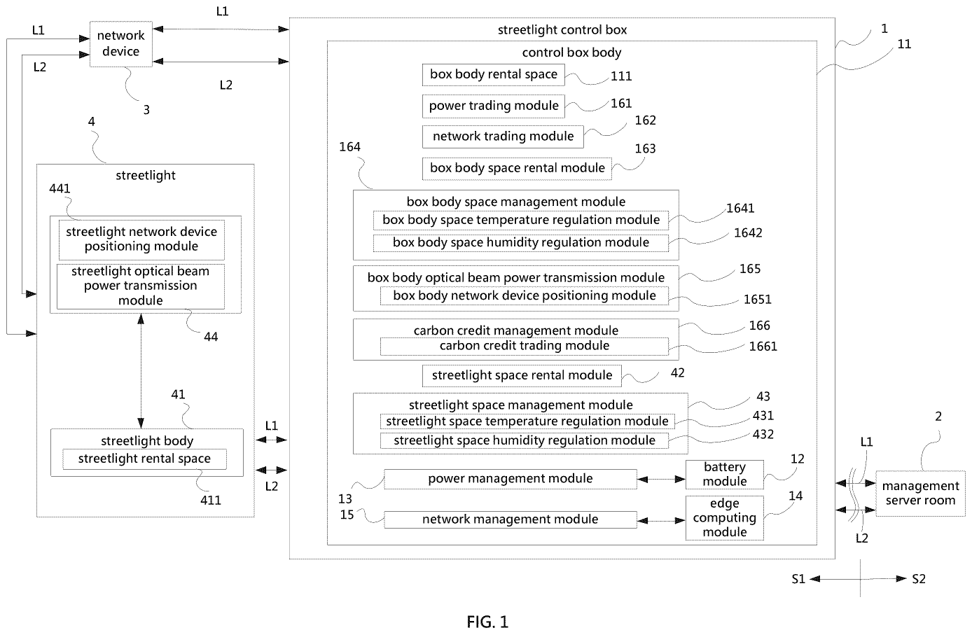

For a detailed description of the embodiments disclosed in the present application, please refer to FIGS. 1 to 6.

In the embodiment shown in FIGS. 1 to 3, a streetlight control box 1 and a streetlight 4 are disclosed, both disposed at an edge side S1. The streetlight control box 1 may be used to control the streetlight 4 and is configured to cooperate with a power circuit L1 and a network circuit L2, such that the power circuit L1 and the network circuit L2 respectively provide or receive power and network access.

In this embodiment, the power circuit L1 may be a streetlight circuit connected to the public power grid at the edge side S1, and the network circuit L2 may be a circuit connected to the public network of the smart city at the edge side S1.

The streetlight control box 1 may further cooperate with a management server room 2 and a network device 3. In this embodiment, the management server room 2 is located at a management side S2 and provides a management server room network message. The network device 3 is located at the edge side S1 and provides a network device message. The management side S2 is located remotely, allowing the management server room 2 to be installed at the operator's end (e.g., power or network operator). The edge side S1 is located locally, and the network device 3 may be installed within the streetlight control box 1 or the streetlight 4.

It should be noted that the network device 3 may be an unmanned vehicle or a network device that seeks services by providing network device messages via wired or wireless connection through the power circuit L1 and the network circuit L2 to the streetlight control box 1 or the streetlight 4.

In the above embodiment, the streetlight control box 1 comprises: a control box body 11, a battery module 12, a power management module 13, an edge computing module 14, and a network management module 15.

The control box body 11 may serve as the housing of the streetlight control box.

The battery module 12 is configured to store power at the edge side S1. In this application, the battery module 12 may be used for off-peak power storage or green energy storage.

It should be noted that the battery module 12 may be composed of a battery array system and may adopt fuel cells such as hydrogen fuel cells or non-fuel cells such as lithium iron phosphate batteries. Accordingly, the battery module 12 may serve as a localized uninterruptible power supply (UPS) after a power outage of the public grid, providing power to the streetlight control box 1 or the streetlight 4, and may even provide power back to the public power grid via the power circuit L1. Therefore, the streetlight control box 1 may integrate with the public grid and function as a regional power center in the smart city to support grid stability and power demand balancing.

The power management module 13 is connected to the power circuit L1 and the battery module 12 and is configured to provide power management by executing a circuit power supply mode and a battery power supply mode.

Specifically, when the power management module 13 executes the circuit power supply mode, the power management module 13 enables the power circuit L1 to provide power to the network device 3, allowing the public grid to supply power to the network device 3 via the power circuit L1. When executing the battery power supply mode, the power management module 13 enables the battery module 12 to provide power to the network device 3 via the power circuit L1 without relying on the public grid. Furthermore, after a power outage, the battery module 12 may even supply power back to the public grid.

In addition, the power management module 13 may execute power circuit management and battery energy storage management. The power management module 13 may comprise a power meter, power distribution panel (PDP), power monitoring system, and a lighting controller gateway, enabling it to monitor and control power supply through the power circuit L1. The battery energy storage management function allows the power management module 13 to manage the battery module 12 for off-peak charging and peak-time discharging. The battery module 12 can serve as a UPS to mitigate grid load fluctuations. The power management module 13 may optionally comprise a storage component, battery management system, battery cabinet, fuel cell, power conversion and regulation system (PCS), and an energy management system (EMS) to support an automatic frequency control (AFC) system. This allows frequency modulation to be performed during supply-demand imbalances or generator failure. Additionally, the power management module 13 may optionally comprise a solar panel, enabling AC/DC conversion through a hybrid inverter for power storage or supply by the battery module 12.

Optionally, the streetlight control box 1 further comprises a power trading module 161, which is configured to trade power with the network device 3 or the power circuit L1.

It should be noted that when the power trading module 161 trades power with the network device 3, the power management module 13 enables the power circuit L1 to supply the traded power to the network device 3. When trading with the power circuit L1, the power management module 13 enables the battery module 12 to supply the traded power to the power circuit L1 and thereby to the management server room 2. The power trading module 161 may monitor the status of the network device 3 and battery module 12 via the power management module 13 and interface with a trading platform of a service or power operator through a telecom network (comprising SDN systems) to perform subsequent transactions such as pricing, leasing, bidding, or auction.

Optionally, the streetlight control box 1 further comprises a carbon credit management module 166 and a carbon credit trading module 1661. The carbon credit management module 166 is connected to the power circuit L1 and acquires the power usage status of the power circuit L1 for the network device 3 to perform carbon credit management. The carbon credit trading module 1661 is connected to the carbon credit management module 166 and acquires the carbon credit management status to perform carbon credit trading.

It should be noted that the power management module 13 may install a monitoring system for the power usage of the network device 3, enabling the carbon credit management module 166 to acquire such power usage via the power management module 13 for carbon credit management. In addition, the power trading module 161 and the carbon credit trading module 1661 may connect via a telecom network (comprising SDN systems) to the trading platforms of service or power operators for subsequent transactions related to electricity and carbon credits, such as pricing, leasing, bidding, or auction. Accordingly, the streetlight control box 1 may integrate trading platforms of power exchanges and carbon credit exchanges to meet the future needs of industry power and carbon credit trading.

The edge computing module 14 is configured to perform edge computing on the network device message at the edge side S1 to generate an edge computing network message.

It should be noted that the edge computing module 14 may optionally comprise a cache module, a mobile edge computing (MEC) platform, a radio intelligent controller (RIC), a user plane function (UPF), a central/distributed unit (C/DU), a grandmaster clock, and a precision time protocol (PTP) switch, thereby forming a mobile edge computing or multi-access edge computing center. The edge computing module 14 is thus capable of providing high-bandwidth, low-latency edge computing services for network devices such as mobile base stations or unmanned vehicles.

The network management module 15 is connected to the network circuit L2 and the edge computing module 14 and is configured to provide network management by executing a network message transmission mode and an edge computing mode.

Specifically, when executing the network message transmission mode, the network management module 15 enables the network circuit L2 to provide the network for the management server room 2 and the network device 3 to transmit the network device message to the management server room 2 for non-edge computing, and then transmit the non-edge-computed management server room network message back to the network device 3. When executing the edge computing mode, the network management module 15 enables the network circuit L2 to provide the network for the edge computing module 14 and the network device 3 to transmit the network device message to the edge computing module 14 for edge computing, and then transmit the resulting edge computing network message back to the network device 3.

Optionally, the streetlight control box 1 further comprises a network trading module 162, which is configured to trade the network with the network device 3 or the network circuit L2. It should be noted that when the network trading module 162 trades the network with the network device 3, the network management module 15 enables the network circuit L2 to provide the traded network to the network device 3. When the network trading module 162 trades the network with the network circuit L2, the network management module 15 enables the network circuit L2 to receive the traded network.

It should be noted that the network management module 162 or network management module 15 may establish a monitoring system for the network traffic usage status of the network device 3, so that the network trading module 162 may obtain the network traffic usage status of the network device 3 via the network management module 162 or network management module 15. Subsequently, it may connect to the trading platform of the service provider through a telecommunication network (comprising software-defined network systems) to conduct network-related transactions such as pricing, leasing, and maintenance. The network management module 162 or network management module 15 may manage network circuits and network traffic (inbound and outbound). Network circuit management primarily provides management for optical cross-connection processing to handle external and internal network connections required for fiber optic transmission. For this purpose, the network management module 162 or network management module 15 may optionally comprise an Optical Main Distribution Frame (OMDF), an Optical Line Protection (OLP) device, a Wavelength Division Multiplexing (WDM) device, and a Remote Fiber Test System (RFTS). Additionally, for network traffic management, the network management module 162 or network management module 15 may optionally comprise a software-defined Wide Area Network (WAN), a radio network, and a cybersecurity management system. The cybersecurity system may comprise mechanisms such as a Firewall, Deep Packet Inspection (DPI), and an Intrusion Prevention System (IPS).

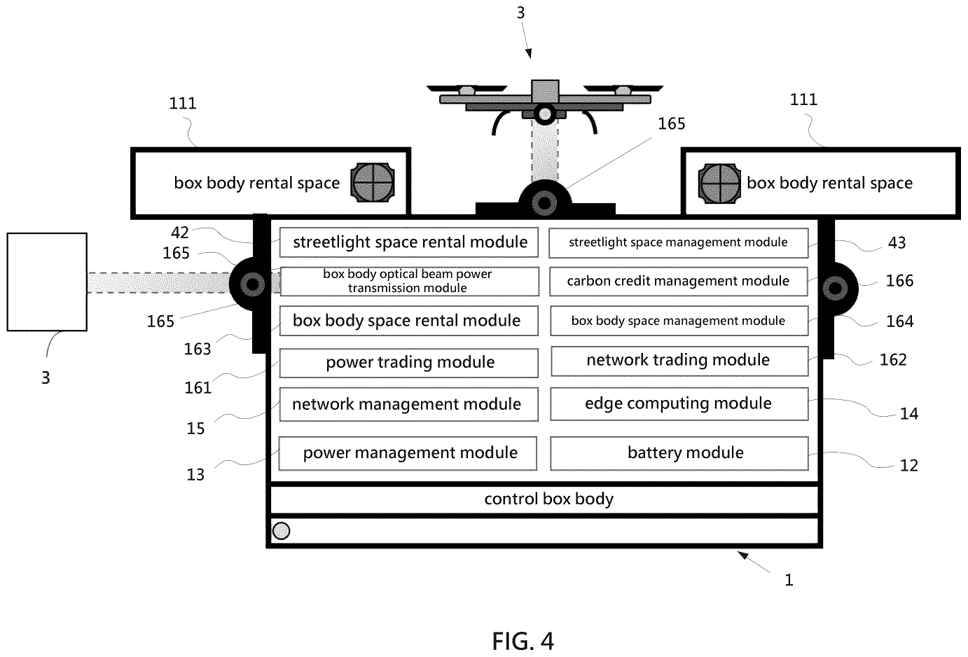

Optionally, in the embodiment shown in FIG. 4, the streetlight control box 1 further comprises a box body space rental module 163 and a box body space management module 164. Accordingly, the control box body 11 comprises a box body rental space 111. The box body space rental module 163 is configured to rent the box body rental space 111 so that the network device 3 can operate within it. The box body space management module 164 provides environmental management for the box body rental space 111 to meet the operating requirements of the network device 3.

It should be noted that the box body space rental module 163 may also support future transaction processing based on the operating status of the network device 3 within the box body rental space 111. This comprises usage time, power/charging status, battery replacement, information exchange volume/traffic, processor and hard disk utilization, and other operational parameters.

It should be noted that the box body space management module 164 can perform centralized environmental monitoring through a central environmental management platform. It can monitor external and internal environmental conditions of the box body rental space 111, comprising microclimate information such as wind, rainfall, temperature, humidity, as well as air conditioning, cooling systems, security, fire protection, equipment condition, and more. It can also perform tasks such as hatch operation, charging activation and termination, automatic navigation and docking, RTK base station and computation server management, image storage, and recognition, ensuring the environment is suitable for the operation of the network device 3.

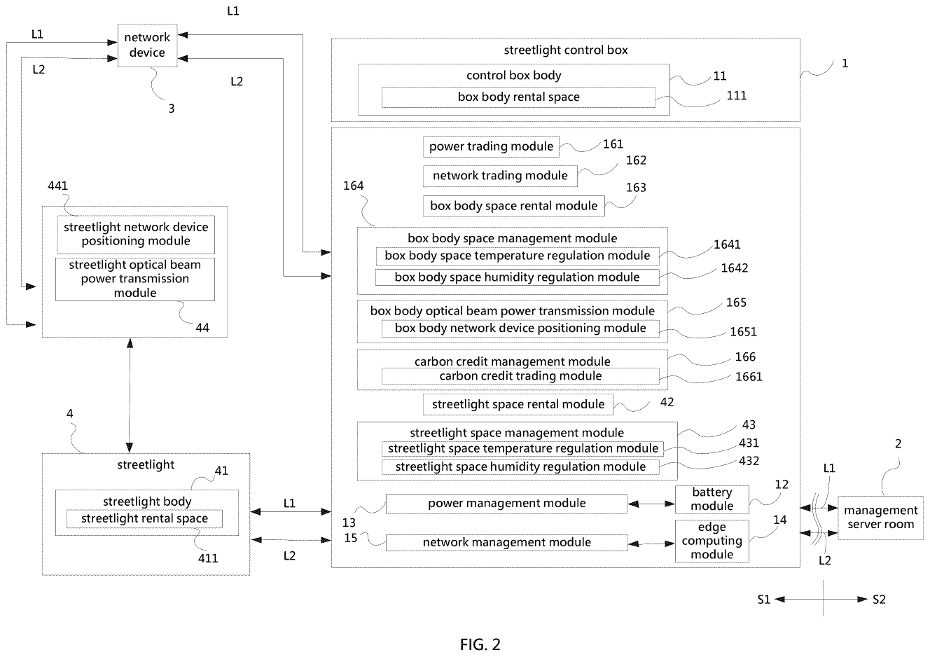

Optionally, in the embodiments shown in FIGS. 1 and 2, the streetlight control box 1 further comprises a box body space temperature regulation module 1641 and a box body space humidity regulation module 1642. It should be noted that the box body space humidity regulation module 1642 may comprise a liquid-cooled cooling device with advantages of low noise and low energy consumption.

It should be noted that the box body space management module 164 is respectively connected to the box body space temperature regulation module 1641 and the box body space humidity regulation module 1642, thereby regulating the temperature and humidity of the box body rental space 111 environment.

It should be noted that the box body rental space 111 may supply power and network to the network device 3, allowing it to perform operations such as charging, battery replacement, information exchange, and data storage. Additionally, the streetlight control box 1 may optionally install a charging device (e.g., solar panel, charging plate, or laser transmitter), a protection device (e.g., hatch, drone landing platform, drying device, or vehicle stabilization device), and a network device body (e.g., camera, RTK mobile station, adjustable charging device, battery, or photovoltaic cell) within the box body rental space 111.

Optionally, the streetlight control box 1 further comprises a box body optical beam power transmission module 165. The power management module 13 is connected to the box body optical beam power transmission module 165. When the power management module 13 executes the circuit power supply mode, it can transmit power through an optical beam via the module 165 so that the power circuit L1 provides power to the network device 3. When executing the battery power supply mode, it can transmit power through the module 165 so that the battery module 12 supplies power to the network device 3 via the power circuit L1.

Accordingly, the streetlight control box 1 further comprises a box body network device positioning module 1651. The box body optical beam power transmission module 165 is connected to the module 1651 and can locate the network device 3 to supply power via optical beam.

It should be noted that the box body optical beam power transmission module 165 may comprise a photoelectric converter, a laser beam emitter, and a laser beam receiver to supply power to the network device 3 via laser beam. Thus, when the power circuit L1 fails, the module 165 can provide backup power. Furthermore, it can perform remote power supply to network devices such as unmanned vehicles.

It should be noted that the module 165 can supply power to the network device 3 via wired or wireless means, using Power over Fiber (PoF) or Power over Free Space.

It should be noted that the module 165 can provide a beam power transmission safety mechanism. If a foreign object intrudes during wireless beam power transmission, the mechanism can shut off the power transmission to avoid potential hazards.

It should be noted that the module 1651 can recognize, locate, and lock onto the remote network device 3 so that the module 165 can provide remote charging. It can also target and destroy hostile remote objects via laser beam.

It should be noted that components such as the battery module 12, power management module 13, edge computing module 14, network management module 15, power trading module 161, network trading module 162, box body space rental module 163, box body space management module 164, temperature regulation module 1641, humidity regulation module 1642, optical beam power transmission module 165, positioning module 1651, carbon credit management module 166, and carbon credit trading module 1661 can be installed inside or outside the control box body 11. For example, the battery module 12 may also be installed in the network device 3.

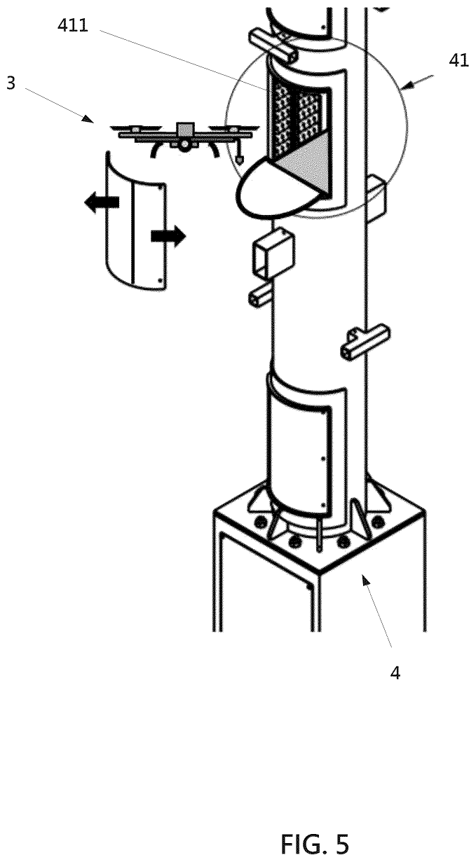

In the embodiment shown in FIGS. 1 to 3, the streetlight 4 comprises a streetlight body 41, a streetlight space rental module 42, and a streetlight space management module 43. As shown in FIG. 5, the body 41 comprises a streetlight rental space 411. The rental module 42 allows the network device 3 to operate within the space 411. The management module 43 manages the environment to meet operational requirements.

Optionally, the streetlight 4 further comprises a temperature regulation module 431 and a humidity regulation module 432. Preferably, the temperature module 431 may comprise a low-noise, low-energy liquid-cooled device.

It should be noted that the module 43 is connected to modules 431 and 432 to regulate the temperature and humidity of space 411.

It should be noted that the rental space 411 supplies power and network to device 3 for operations such as charging, battery replacement, information exchange, and data storage. Optionally, charging devices, protection devices, or network device bodies may be installed.

Optionally, the streetlight 4 further comprises an optical beam power transmission module 44. The power management module 13 is connected to module 44. It supplies power via optical beam in both circuit and battery supply modes.

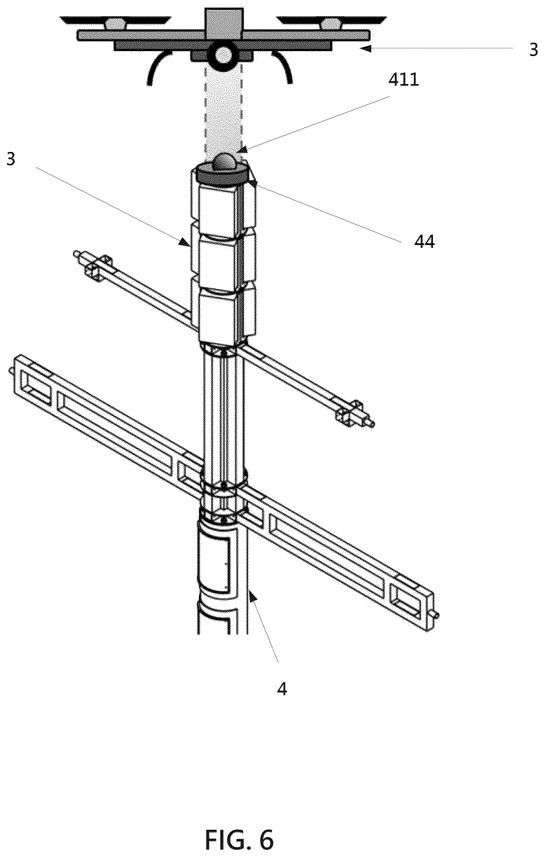

In FIG. 6, the streetlight 4 further comprises a positioning module 441 connected to module 44 to locate device 3 for beam power delivery.

It should be noted that module 44 may comprise a photoelectric converter, a laser beam emitter, and a laser beam receiver. It may provide backup power and remote power to devices like unmanned vehicles.

It should be noted that the battery module 12, modules 42, 43, 431, 432, 44, and 441 can be installed in the body 41 or control box body 11.

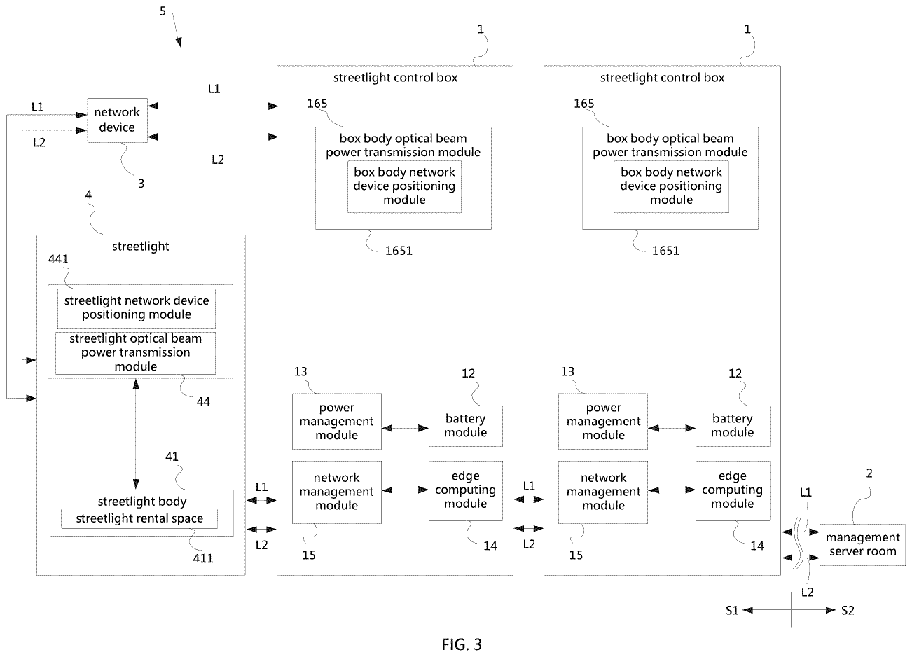

In FIG. 3, a smart city streetlight control system 5 is disclosed, comprising multiple control boxes 1 that may supply power to one another via optical beam transmission using module 165.

It should be noted that certain components may be omitted. For example, a basic control box comprises: control box body, battery module, power management module, edge computing module, and network management module. The battery module stores power at the edge. The power management module connects to both power circuit and battery, executing circuit and battery supply modes. The edge computing module processes device information at the edge. The network management module connects the circuit and edge module, managing both network message transmission and edge processing.

The streetlight comprises a body and a rental module, with a rental space that allows network devices to operate.

The smart city control system comprises multiple control boxes that can transmit power to one another via optical beam.

In summary, the system enables widespread installation of network devices in public areas, offering network, power, and edge computing services for smart city development. The control box may comprise a battery module that serves as an uninterruptible power system when the public grid fails, ensuring continuous power supply for devices and circuits across the city.

The examples above are only illustrative to explain principles and effects of the invention, but not to limit the invention. It will be apparent to those skilled in the art that modifications and variations can be made without departing from the spirit and scope of the invention. Therefore, the protection range of the rights of the invention should be as defined by the appended claims.

What is claimed is:

1. A streetlight control box disposed at an edge side and configured to cooperate with a power circuit and a network circuit to provide power and a network respectively from the power circuit and the network circuit, the streetlight control box further being configured to cooperate with a management server room and a network device, wherein the management server room is located at a management side and is configured to provide a management server room network message, and the network device is located at the edge side and is configured to provide a network device message, wherein the management side is located remotely, and the edge side is located locally; the streetlight control box comprises:
a control box body;
a battery module configured to store the power at the edge side;
a power management module, connected to the power circuit and the battery module, and configured to provide power management by activating a circuit power supply mode and a battery power supply mode, wherein, when the circuit power supply mode is activated, the power management module enables the power circuit to supply the power to the network device; when the battery power supply mode is activated, the power management module enables the battery module to supply the power to the network device via the power circuit;
an edge computing module configured to perform edge computing on the network device message at the edge side so as to generate an edge computing network message; and
a network management module connected to the network circuit and the edge computing module, and configured to provide network management by activating a network message transmission mode and an edge computing mode, wherein, when the network message transmission mode is activated, the network management module enables the network circuit to provide the network for the management server room and the network device, so as to transmit the network device message to the management server room or transmit the management server room network message to the network device; when the edge computing mode is activated, the network management module enables the network circuit to provide the network for the edge computing module and the network device, so as to transmit the network device message to the edge computing module and transmit the edge computing network message to the network device.

2. The streetlight control box of claim 1, wherein the battery module is disposed in the network device.

3. The streetlight control box of claim 1, further comprising a carbon credit management module connected to the power circuit and for acquiring statuses of the power supplied by the power circuit to the network device, thereby providing carbon credit management.

4. The streetlight control box of claim 3, further comprising a carbon credit trading module connected to the carbon credit management module and for acquiring carbon credit management statuses from the carbon credit management module, thereby providing carbon credit trading.

5. The streetlight control box of claim 1, further comprising a power trading module configured to trade the power with the network device or the power circuit, wherein, when the power trading module trades the power with the network device, the power management module enables the power circuit to supply the traded power to the network device; and when the power trading module trades the power with the power circuit, the power management module enables the battery module to supply the traded power to the power circuit.

6. The streetlight control box of claim 1, further comprising a network trading module configured to trade the network with the network device or the network circuit, wherein, when the network trading module trades the network with the network device, the network management module enables the network circuit to provide the traded network for the network device; and when the network trading module trades the network with the network circuit, the network management module enables the network circuit to receive the traded network.

7. The streetlight control box of claim 1, further comprising a box body space rental module, wherein the control box body comprises a box body rental space, and the box body space rental module is configured to rent the box body rental space so as to allow the network device to operate within the box body rental space.

8. The streetlight control box of claim 7, further comprising a box body space management module configured to manage an environment of the box body rental space to meet operating requirements of the network device.

9. The streetlight control box of claim 8, further comprising a box body space temperature regulation module, wherein the box body space management module is connected to the box body space temperature regulation module and regulates temperature of the environment of the box body rental space via the box body space temperature regulation module.

10. The streetlight control box of claim 8, further comprising a box body space humidity regulation module, wherein the box body space management module is connected to the box body space humidity regulation module and regulates humidity of the environment of the box body rental space via the box body space humidity regulation module.

11. The streetlight control box of claim 1, further comprising a box body optical beam power transmission module, wherein the power management module is connected to the box body optical beam power transmission module, and when the circuit power supply mode is activated, the power management module transmits the power via the box body optical beam power transmission module through an optical beam, thereby enabling the power circuit to supply the power to the network device; and when the battery power supply mode is activated, the power management module transmits the power via the box body optical beam power transmission module, thereby enabling the battery module to supply the power to the network device via the power circuit.

12. The streetlight control box of claim 11, further comprising a box body network device positioning module, wherein the box body optical beam power transmission module is connected to the box body network device positioning module, and is configured to locate the network device via the box body network device positioning module and to supply the power to the located network device through the optical beam.

13. The streetlight control box of claim 1, wherein the battery module, the power management module, the edge computing module, and the network management module are disposed inside or outside the control box body.

14. A streetlight configured to cooperate with the streetlight control box of claim 11 and located at the edge side, the streetlight comprising a streetlight body and a streetlight space rental module, wherein the streetlight body comprises a streetlight rental space, and the streetlight space rental module is configured to rent the streetlight rental space so as to allow the network device to operate within the streetlight rental space.

15. The streetlight of claim 14, wherein the battery module is disposed in the streetlight body or the control box body, and the streetlight space rental module is disposed in the streetlight body or the control box body.

16. The streetlight of claim 14, further comprising a streetlight space management module configured to manage an environment of the streetlight rental space to meet operating requirements of the network device.

17. The streetlight of claim 16, further comprising a streetlight space temperature regulation module, wherein the streetlight space management module is connected to the streetlight space temperature regulation module and regulates temperature of the environment of the streetlight rental space via the streetlight space temperature regulation module.

18. The streetlight of claim 16, further comprising a streetlight space humidity regulation module, wherein the streetlight space management module is connected to the streetlight space humidity regulation module and regulates humidity of the environment of the streetlight rental space via the streetlight space humidity regulation module.

19. The streetlight of claim 14, further comprising a streetlight optical beam power transmission module, wherein the power management module is connected to the streetlight optical beam power transmission module, and when the circuit power supply mode is activated, the power management module transmits the power via the streetlight optical beam power transmission module through an optical beam, thereby enabling the power circuit to supply the power to the network device; and when the battery power supply mode is activated, the power management module transmits the power via the streetlight optical beam power transmission module, thereby enabling the battery module to supply the power to the network device via the power circuit.

20. The streetlight of claim 19, further comprising a streetlight network device positioning module, wherein the streetlight optical beam power transmission module is connected to the streetlight network device positioning module, and the streetlight optical beam power transmission module is configured to locate the network device via the streetlight network device positioning module and to supply the power to the located network device through the optical beam.

21. A smart city streetlight control system comprising:
a plurality of streetlight control boxes of claim 1, wherein the streetlight control boxes are configured to provide the power for each other via optical beams.
